(19) United States
(12) Patent Application Publication
(10) Pub. No.: US 2020/0342691 A1
(43) Pub. Date: Oct. 29, 2020

(54) METHOD AND CONTROL UNIT FOR TRANSFERRING INFORMATION TO AND/OR FROM A VEHICLE

(71) Applicant: Scania CV AB, Södertälje (SE)

(72) Inventors: Alexander SAERS, Hägersten (SE); Henrik FELIXSON, Stockholm (SE); Simon WRETBLAD, Stockholm (SE); Magnus ERIKSSON, Tullinge (SE)

(73) Assignee: Scania CV AB, Södertälje (SE)

(21) Appl. No.: 16/956,999

(22) PCT Filed: Dec. 11, 2018
(86) PCT No.: PCT/SE2018/051281

§ 371 Date: Jun. 22, 2020

(30) Foreign Application Priority Data
Dec. 27, 2017 (SE) 1751651-9

(51) Int. Cl. G07C 5/00; H04W 4/44; G06F 9/54

(52) U.S. Cl. CPC G07C 5/008; G06F 9/541; H04W 4/44

(57) ABSTRACT

Provided is a system for transferring information to and/or from a vehicle comprising: at least one internal system; at least one add-on system arranged in the vehicle after the vehicle is manufactured; and at least one internal communication unit configured to communicate with at least one vehicle external communication unit. The method comprises: configuring an add-on interface of the vehicle by defining a relationship between a first information format used by the at least one internal communication unit and a second information format used by one or more of the at least one internal system and the at least one add-on system; converting, using the configured add-on interface, information between the first information format and the second information format; and transferring the information to and/or from the vehicle, using the at least one internal communication unit, the at least one vehicle external communication unit, and the first information format.

### CROSS-REFERENCE TO RELATED APPLICATIONS

This application is a national stage application (filed under 35 § U.S.C. 371) of PCT/SE2018/051281, filed Dec. 11, 2018 of the same title, which, in turn, claims priority to Swedish Application No 1751651-9 filed Dec. 27, 2017; the contents of each of which are hereby incorporated by reference.

### FIELD OF THE INVENTION

The present invention relates to a method for transferring information to and/or from a vehicle. The present invention also relates to a control unit arranged for transferring information to and/or from a vehicle. The present invention also relates to a computer program and a computer-readable medium comprising instruction for carrying out the method according to the invention.

### BACKGROUND OF THE INVENTION

The following background information is a description of the background of the present invention, which thus not necessarily has to be a description of prior art.

Vehicle manufacture may be conducted in a variety of ways. In for example the car industry, the manufacturer usually produces vehicles that are complete and intended for direct delivery to final customers.

The heavy vehicle industry, however, commonly also employs other kinds of production methods. Manufacturers of heavy vehicles may, as in the car industry, produce vehicles intended for delivery directly to final customers or final users of the vehicles. However, it is also common that heavy vehicles produced by the manufacturer are only partly manufactured, i.e. are only completed to a certain extent, including vehicle internal systems, in view of being subsequently completed by another part than the manufacturer, for example a user or a customer of the manufacturer, e.g. a third-party supplier, in such a way as to meet specific requirements of the final customers or users.

It may also be that the vehicle, although substantially completed by its manufacturer, will be provided with further functionalities and/or systems, in this document denoted add-on systems, e.g. by another party such as a third-party supplier, a customer, or a final user, before it is put into use. It is for example usual that commercial vehicle manufacturers, as well as producing fully equipped vehicles, produce also vehicle versions being only partly manufactured, for example intentionally comprising only the chassis, or the chassis and the driver compartment/cab. The partially manufactured vehicle is then intended to be subsequently completed with one or more additional systems and/or functionalities by another party than the manufacturer, in accordance with the specific requirements of another party, being e.g. a final customer and/or final user.

For example, chassis produced by a vehicle manufacturer may be designed to be usable in any desired way as bases for building on in order to construct mobile homes, fire vehicles, ambulances, concrete mixer trucks, refrigerated vehicles, or any other especially adapted vehicle. Also, for example a bus chassis may be produced by the vehicle manufacturer with little or no bodywork, with the intention to complete the vehicle with subsequent building-on performed by a bus bodybuilder. Generally, a bodybuilder installs/adds one or more add-on systems, i.e. does bodywork, on a vehicle after its original manufacture.

Thus, the building-on and/or addition of one or more systems and/or functionalities carried out by another party may be very extensive, and at least some building-on is also very common in the case of heavy vehicles. For this reason, the vehicle manufacturer often also prepares the vehicle in such a way as to facilitate subsequent building-on.

For example, one or more power takeoffs are often included in the vehicle by the manufacturer, e.g. so that add-on systems may be connected for example to the vehicle's engine and/or gearbox to enable them to be provided with driving power from the vehicle. There may also be connections to make it possible to use, for example, the vehicle's electrical system, hydraulic system and/or pneumatic system for implementation of add-on functions. A vehicle may thus be provided with a plurality of power takeoffs, and the power takeoff requirement may vary depending on the kinds of applications built onto the vehicle. Certain applications may for example require power which is constantly available when the engine of the vehicle is running, irrespective of whether the vehicle is moving or not, e.g. in the case of concrete mixer trucks, refrigeration units in refrigerated vehicles. Other applications may only need power on distinct occasions, e.g. upon activation of an additional system. The activation of a power takeoff for, and hence activation of the operation of, one or more built-on systems and/or functionalities is often not such that continuous or unregulated power takeoff is desirable, since it is only usually required in certain situations, e.g. upon a demand from the built-on systems and/or functionalities themselves or from, for example, the vehicle's driver.

### SUMMARY OF THE INVENTION

The one or more add-on systems being implemented in the vehicle are often unknown for the vehicle internal systems, i.e. for the internal systems being provided by the manufacturer. Thus, the one or more add-on systems may be unknown for manufacturer of the vehicle, and therefore also initially for the add-on interface of the vehicle. Generally, the manufacturer cannot, already when the vehicle is produced, know which add-on systems that will be added to the vehicle later on, and the vehicle can therefore obviously also not possibly be equipped to interact with such unknown add-on systems.

Thus, it may be impossible to perform actions, functions and/or operations in the vehicle and/or in offboard entities being related to the vehicle based e.g. on signals provided by the add-on systems, since the signals cannot even be interpreted by the vehicle internal systems and/or the add-on interface. Hereby, there is a risk that important actions, functions and/or operations are not properly performed in the vehicle and/or in the offboard entities.

Specifically, since the unknown add-on systems are not initially defined in the add-on interface, it may be impossible for off-board entities, such as e.g. bodywork entities/interfaces, diagnosis entities/interfaces and/or manufacturer entities/interfaces, to communicate with the add-on systems, since they may be incompatible with each other.

It is therefore an object to solve at least some of the above-mentioned disadvantages.

The object is achieved by a method for transferring information to and/or from a vehicle, the vehicle including:
at least one vehicle internal system;
at least one add-on system, the add-on system being arranged in the vehicle after the vehicle is produced by a manufacturer; and
at least one internal communication unit arranged for communication with at least one vehicle external communication unit.

The method includes:
configuring an add-on interface of the vehicle by defining at least a relationship between a first information format used by the at least one internal communication unit and a second information format used by one or more of the at least one vehicle internal system and the at least one add-on system;
converting, by usage of the configured add-on interface, information between the first information format and the second information format; and
transferring the information to and/or from the vehicle, by usage of the at least one internal communication unit, the at least one vehicle external communication unit, and the first information format.

According to embodiments of the present invention, the second information format may be used by both the at least one vehicle internal system and the at least one add-on system.

By configuring the add-on interface such that the add-on interface has knowledge of the relationship between the first information/data format and the second information/data format, the add-on interface is able to convert information/data between the first information format and the second information format. Hereby, a communication between essentially any offboard entity, and the at least one vehicle internal system and/or the at least one add-on system is made possible, such that information reliably and securely may be transferred between onboard and offboard entities/systems.

The first information format may be used by an offboard entity, such as a diagnosis tool/interface, a bodywork interface, a manufacturer interface, or any other suitable offboard entity being related to the vehicle. The first information format may also be used for the transfer of information to and/or from the vehicle, i.e. may be used for the connection/communication of information between the at least one internal communication unit and the at least one external communication unit. The first information format may also be used for onboard transfer of information between the add-on interface and the at least one internal communication unit. The first information format may be characterized by one or more information related features, such as for example including a representation of the information, comprising e.g. digital signals and/or values corresponding to the information, analog signals and/or values corresponding to the information, optical signals and/or values corresponding to the information, wireless signals corresponding to the information, numerical values corresponding to the information, a modulation corresponding to the information, and/or a signal modification corresponding to the information. The first information format may also be characterized by one or more presentation related features, such as for example how the information is divided into packets being transferred, and/or the size and/or the contents/fields of packets carrying the information.

The second information format may be used by the onboard transfer of information between the add-on interface, and the at least one vehicle internal system and/or at least one add-on system. By configuring the add-on interface such that it may perform the conversion between the first and second information format, a reliable and secure communication between the offboard and onboard entities is provided. This configuration of the add-on interface may be achieved remotely, without having to take the vehicle into a work shop, as is explained more in detail below. The second information format may be characterized by one or more information related features, such as for example including a representation of the information, comprising e.g. digital signals and/or values corresponding to the information, analog signals and/or values corresponding to the information, optical signals and/or values corresponding to the information, wireless signals corresponding to the information, numerical values corresponding to the information, a modulation corresponding to the information and/or a signal modification corresponding to the information. The second information format may also be characterized by one or more presentation related features, such as for example how the information is divided into packets being transferred, and/or the size and/or the contents/fields of packets carrying the information.

Hereby, add-on systems may easily and cost-efficiently be added/implemented in the vehicle after its manufacture, since communication with these added add-on system is easily achieved, without causing vehicle off road time periods. Thus, a vehicle being very flexible from a bodywork point of view is provided by usage of the present invention.

Also, the add-on systems being added to the vehicle may use the communication provided already by the manufacturer, i.e. may communicate with the offboard entities/systems using a communication subscription already available from the manufacture of the vehicle, which of course reduces the costs.

Thus, by way of embodiments of the present invention, the addition of an add-on system to the vehicle is facilitated.

According to an embodiment of the present invention
the converting includes:
receiving information on the second information format from one or more of the at least one vehicle internal system and at least one add-on system; and
converting, by usage of the configured add-on interface, the information to the first information format; and
the transferring includes:
transmitting the information from the at least one internal communication unit to the at least one vehicle external communication unit on the first information format.

Hereby, an uplink transmission of information/data, i.e. transmission of information/data from systems onboard the vehicle to any entity offboard the vehicle, is provided. The onboard systems and the offboard entities may thus communicate with each other although they use differing information formats. This is made possible by the conversion performed by the add-on interface.

According to an embodiment of the present invention, the configuring further includes defining at least one trigger condition, the trigger condition indicating when the transmitting of the information should be performed.

Thus, the add-on interface may be configured to execute uplink transmission of information/data when the at least one trigger condition is fulfilled. Hereby, the uplink flow of information/data may be regulated such that it is matched to the needs and/or capabilities of the onboard systems providing the information/data and/or of the offboard entities receiving the information/data. For the intelligent add-on interface used by the embodiments of the present invention, the trigger conditions may be made very simple, or may be composed of more complex conditions. Trigger conditions of essentially any complexity level may be utilized, which increases the flexibility of the communication.

According to an embodiment of the present invention, the definition of the trigger condition is related to one or more of:
the at least one vehicle internal system; and
the at least one add-on system.

Essentially any signals, states, parameters and/or conditions of one or more onboard systems may be taken into consideration when triggering the uplink transmission from the vehicle, which provides for a flexible way of controlling the uplink information flow.

According to an embodiment of the present invention, the at least one trigger condition is defined based on input provided by one or more of:
a final user of the vehicle;
at least one other part than the manufacturer, the at least one other part providing the at least one add-on system; and
the manufacturer.

Thus, the trigger condition may be flexibly updated/configured based on input information provided by a number of sources. Essentially anyone with knowledge of the add-on and/or vehicle internal systems may provide this input, which provides for a very flexible control of the uplink transmissions.

According to an embodiment of the present invention,
the transferring includes:
receiving information on the first information format from the at least one external communication unit; and
the converting includes:
converting, by usage of the configured add-on interface, the information to the second information format; and
providing the information on the second information format to one or more of the at least one vehicle internal system and the at least one add-on system.

Hereby, a downlink transmission of information/data, i.e. transmission of information/data from offboard entities/systems to systems onboard the vehicle, is provided. The onboard systems and the offboard entities may thus communicate with each other although they use differing information formats. This is made possible by the conversion performed by the add-on interface.

According to an embodiment of the present invention, the definition of the relationship between the first information format and the second information format is based on input provided by one or more of:
a final user of the vehicle;
at least one other part than the manufacturer, the at least one other part providing the at least one add-on system;
at least one other part than the manufacturer, the at least one other part having knowledge of the at least one add-on system; and
the manufacturer.

Thus, the add-on interface may be flexibly updated/configured based on configuration information including the definition of the relationship between the first information format and the second information format provided by a number of sources. Essentially anyone with knowledge of the offboard systems and/or of the onboard internal and/or add-on systems may be able to update the add-on interface, wherefore the vehicle does not have to go to the workshop for the update/configuration. The vehicle off road time and the update costs are hereby greatly reduced.

The object is also achieved by the above-mentioned control system arranged for transferring information to and/or from a vehicle, the vehicle including:
at least one vehicle internal system;
at least one add-on system, the add-on system being arranged in the vehicle after the vehicle is produced by a manufacturer; and
at least one internal communication unit arranged for communication with at least one vehicle external communication unit;

The control unit is arranged for:
configuring an add-on interface of the vehicle by defining at least a relationship between a first information format used by the at least one internal communication unit and a second information format used by one or more of the at least one vehicle internal system and the at least one add-on system;
converting, by usage of the configured add-on interface, information between the first information format and the second information format; and
transferring the information to and/or from the vehicle, by usage of the at least one internal communication unit, the at least one vehicle external communication unit, and the first information format.

The control unit has advantages corresponding to the advantages mentioned above for the method.

The object is also achieved by the above-mentioned computer program and computer-readable medium.

Detailed exemplary embodiments and advantages of the method, control system, computer program and computer-readable medium according to the invention will below be described with reference to the appended drawings illustrating some preferred embodiments.

### BRIEF DESCRIPTION OF THE DRAWINGS

Embodiments of the invention are described in more detail with reference to attached drawings illustrating examples of embodiments of the invention in which:

FIG. 1 is a schematic illustration of a non-limiting example of a vehicle in which the embodiments of the present invention may be implemented,

FIG. 2 shows a flow chart diagram for some embodiments of the present invention,

FIG. 3 schematically illustrates a vehicle including onboard systems comprising an add-on interface and an offboard entity/system,

FIG. 4 schematically illustrates a non-limiting example of a system, in which embodiments of the present invention may be implemented, and

FIG. 5 is a schematic illustration of a control unit according to some embodiments of the present invention.

### DETAILED DESCRIPTION OF THE INVENTION

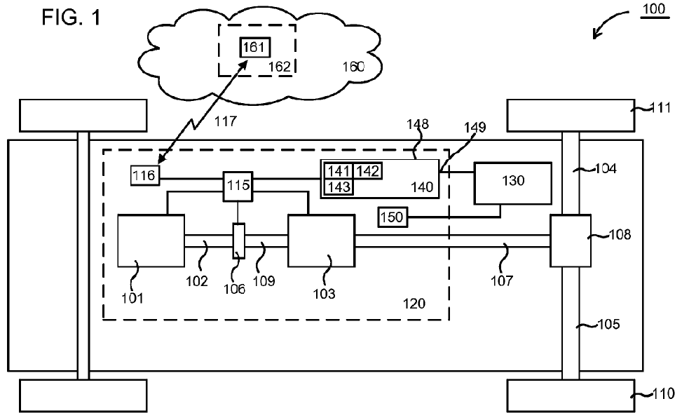

FIG. 1 schematically illustrates a power train in a vehicle 100, in which the embodiments of the present invention may be implemented. The illustrated vehicle 100 has only one axle 104, 105 with tractive/drive wheels 110, 111, but the invention is also applicable to vehicles which have more than one axle provided with tractive wheels. The power train comprises a combustion engine 101 which in a conventional way, via an output shaft 102 of the engine, usually via a flywheel, is connected to a gearbox 103 via a clutch 106 and an input shaft 109 connected to the gearbox 103.

The engine may be controlled by the vehicle's control system via a control unit 115. The clutch 106, which may for example take the form of an automatically controlled clutch, and/or the gearbox 103, which may for example be a conventional automatic gearbox, may also be controlled by means of one or more suitable control units, generally depicted as the control unit 115 in FIG. 1. Thus, the function of the control unit 115 may be provided by two or more control units, as is mentioned more in detail below.

The vehicle 100 may further include at least one internal communication unit 116, being associated/connected to one or more control units 115 of the vehicle. For example, the at least one internal communication unit 116 may be included in a control system network of the vehicle 100. The control system network may, as is described below, essentially include any suitable communication interface facilitating communication between control units/devices/entities in the vehicle 100. For example, the communication interface connects the one or more vehicle internal systems 120 with each other, including connecting the at least one internal communication unit 116 with the control unit 115 and other internal systems 120 of the vehicle 100. Such a communication interface many for example, include a controller area network (CAN), an Ethernet connection, a Flexray bus, a local interconnect network (LIN) bus and/or a WiFi connection.

The at least one internal communication unit 116 is arranged for communication with at least one vehicle external communication unit 161, i.e. arranged for transmitting information to and/or receiving information from the at least one vehicle external communication unit 161. The at least one vehicle external communication unit 161 is arranged outside of the vehicle 100, and may be included in and/or associated/connected to essentially any suitable external device/node/apparatus/entity 162, such as e.g. at least one web and/or internet related unit, at least one internet cloud 160 related unit, at least one infrastructure unit, at least one external communication entity included in at least one other vehicle, at least one server and/or at least one database. The at least one vehicle external communication unit 161 may also be included in and/or associated/connected to essentially one or more of the units/devices/entities 411, 412, 413, 141, 420, 430, 440 of an add-on/bodybuilder network 410, as is described more in detail below.

The communication between the at least one internal 116 and at least one external 161 communication units may be performed by usage of a wireless connection 117, e.g. a connection working according to essentially any suitable wireless standard, specification and/or protocol, such as according to the Global System for Mobile communications (GSM) standard, the General Packet Radio Service (GPRS) standard, the Bluetooth standard, any suitable wireless local area networking (WiFi) standard, any suitable generation of a broadband cellular technology (3G, LTE, 4G, 5G) standard, and/or any other suitable wireless standard. Alternatively, the connection 117 may also be a wired connection, including usage of at least one cable or other wiring equipment.

As illustrated in FIG. 1, an output shaft 107 from the gearbox 103 drives the tractive wheels 110, 111 via a final gear 108, e.g. a conventional differential, and driveshafts 104, 105 which are connected to the final gear.

The engine 101, the clutch 106 and the gearbox 103 may be examples of vehicle internal systems 120. As is understood by a skilled person, the vehicle may include a large number of such vehicle internal systems 120, i.e. systems arranged in the vehicle 100 when it was produced by the manufacturer.

In this document, parts, systems and/or functionalities being included/arranged in the vehicle already at vehicle manufacture/production by the manufacturer is commonly denoted vehicle internal system 120. Correspondingly, parts, systems and/or functionalities being included/arranged in the vehicle after the manufacture/production by the manufacturer is commonly denoted add-on systems 130 in this document. The manufacturer is in this document defined as a producer of the original/initial vehicle, being partly completed with at least one vehicle internal system 120 but lacking the later added at least one add-on system 130. The manufacturer of the partly completed vehicle may also be denoted as original equipment manufacturer (OEM). The one or more add-on systems 130 may be provided by another party, which in this document means a party which may be another and/or independent of the vehicle manufacturer, and to which a vehicle produced by the vehicle manufacturer is directly or indirectly delivered after being manufactured/produced. Thus, the other party may be a customer or a final user, but may also be a third-party supplier, which carries out building-on, i.e. addition of one or more add-on systems 130, before delivery to a final customer.

It should be noted that the vehicle depicted in FIG. 1 is merely one example of how the vehicle might be configured, as the embodiments of the invention are applicable to all types of vehicles, e.g. those with hybrid power trains, electric vehicles and/or other kinds of axle configurations, other types of gearboxes with or without clutches etc.

The one or more add-on systems 130 illustrated in FIG. 1 may be provided with power form one or more takeoffs 150, which may be situated at various locations in the vehicle 100.

The one or more add-on systems 130 may be of various kinds, e.g. one might comprise activation of a crane function via a power takeoff, whereas another might comprise illumination of a certain warning lamp at the vehicle driver's location. Thus, the one or more add-on systems 130 may be of a simple kind, i.e. have a low complexity, but may also have substantially any desired functionality, and thus also any complexity.

The one or more add-on systems 130 may need, i.e. may have a demand for, power to be provided to the add-on systems 130. The one or more add-on systems 130 may also need, i.e. may have a demand for, being able to communicate with an internal control system of the vehicle, in order to be provided with one or more signals, parameters and/or control signals available in the internal control system, and/or to be able to provide one or more signals, parameters and/or control signals to the one or more vehicle internal systems 120 via the vehicle internal control system. The one or more add-on systems 130 may also need, i.e. may have a demand for, being able to communicate with one or more nodes/devices/entities/equipment external from the vehicle.

According to embodiments of the invention, an add-on interface 140 may be arranged or provided in the vehicle 100 as an interface between the at least one vehicle internal system 120 and the at least one add-on system 130.

Power needed by the one or more add-on systems 130 may e.g. be provided by the above mentioned one or more power takeoffs 150 and/or may be provided by the add-on interface 140 arranged for providing communication between the one or more vehicle internal systems 120 and the one or more add-on systems 130. The communication between the one or more vehicle internal systems 120 and the one or more add-on systems 130 is facilitated by the add-on interface 140. Thus, the add-on interface communicates one or more signals, parameters and/or control signals between the one or more vehicle internal systems 120 and the one or more add-on systems 130. Thus, the add-on interface 140 is provided as a general interface between the at least one vehicle internal system 120 and the at least one add-on system 130. The add-on interface includes one or more inputs/outputs, for example input/output pins, to which systems, such as e.g. add-on systems, may be connected. Via these inputs/outputs, signals are received/transmitted to the systems connected to the add-on interface 140. For example, the one or more add-on systems may be connected to one or more inputs of the add-on interface, and may provide signals of any suitable signaling format, which is often related to the specific add-on system providing the signal, to the one or more inputs. Essentially, any signaling format mentioned in this document may be received at the one or more inputs. Correspondingly, signals may also be output on the one or more outputs of the add-on interface 140, on a suitable signaling format.

As mentioned above, the at least one internal communication unit 116, and also other vehicle internal system 120, may be included in a control system network of the vehicle 100, which may include the above-mentioned communication interface connecting the one or more vehicle internal systems 120 with each other. Such a communication interface many for example, include a controller area network (CAN), an Ethernet connection, a Flexray bus, a local interconnect network (LIN) bus and/or a WiFi connection. Such a communication interface may be generally used for connecting units/devices/entities/interfaces in the vehicle 100, such as connecting the add-on systems 130 to the add-on interface 140. The at least one add-on system 130 may be connected to an external control system network input, e.g. an external controller area network (CAN) input 149, of an interface/control unit 148 including the add-on interface 140. Hereby, a connection between the one or more add-on systems 130 and the communication interface, such as e.g. the controller area network (CAN), is provided, which is used for connecting the one or more add-on systems 130 to the one or more vehicle internal systems 120, via the communication interface, e.g. via the controller area network (CAN).

Thus, the one or more add-on systems 130 may need/use various information to be provided to them, from within the vehicle and/or from outside of the vehicle, and may therefore have a demand for communication abilities. The one or more add-on systems 130 may also demand resources from the vehicle, such as e.g. status signals from the vehicle, i.e. the signal state of appropriate outputs of the interface/control unit 148 including/implementing the add-on interface 140. The resources which the one or more add-on systems demand for their functions may for example take the form of a demand for mechanical power, electric power, hydraulic power and/or pneumatic power, and/or may take the form of a demand for at least one signal and/or at least one function of the control system of the vehicle. Normally, a demanded power, requiring activation of a power takeoff 150 has to be demanded from the internal control system of the vehicle 100. Where resources are demanded, they are often not constantly demanded, and are also often not constantly available.

Vehicle manufacturers are reluctant for some other party, e.g. a third-party supplier, to effect changes directly in the internal control system of the vehicle, since this may affect the performance of the vehicle in ways which are both undesirable and difficult to predict. This is also why the vehicle manufacturer provides the add-on interface 140, i.e. a signaling interface which can be used for an add-on system for communication with the internal control system of the vehicle.

The add-on interface 140 may be of various kinds, and may include a number of inputs and outputs, which each may have a certain function assigned to it. One output might for example represent activation of a vehicle internal system 120, e.g. a parking brake activation, and when the parking brake is applied this output might for example be set to a high level, in order thereby to communicate the activation of the internal system, e.g. the parking brake, to the one or more add-on systems 130. As is understood by a skilled person, a large number of other examples of functions, whose status may be signaled in a similar way, may be provided by the add-on interface 140. These signals may then be used by the one or more add-on systems 130, but subject for example to various conditions which usually have to be fulfilled for a certain function to be activated.

Thus, by the add-on interface 140, the vehicle manufacturer may provide a building-on interface to enable communication between the internal systems 120 and the add-on system 130. The add-on interface 140 may for example comprise one or more terminal blocks having a number of inputs/outputs, such that high/low/numerical signals on an output may for example represent a status of a certain function, and this information may be used as a control signal for conditional control of add-on system functions. There may also be inputs, e.g. for conveying from the add-on systems 130 signaling, e.g. such that inputting a high signal level on a certain input indicates a demand for activation of a function having a defined meaning.

As a given chassis configuration may be used for add-on systems within a large number of areas of application, it is often not possible at vehicle manufacturing stage to know the specific intended use of a specific chassis, still less the characteristics of specific add-on systems 130. Thus, the add-on systems may communicate their status, e.g. whether the function is active or inactive, by applying a voltage to an input on the add-on interface 140, which will be communicated further to the internal control system and/or vehicle internal systems 120 by the add-on interface 140. The internal communication system and/or the vehicle internal systems 120 will thus also be aware that add-on systems 130 exist and their status.

Control systems in modern vehicles usually comprise a communication bus system comprising of one or more communication buses arranged for connecting together a number of electronic control units (ECUs), e.g. the control units, or controllers, and various systems/components/devices on board the vehicle. Such a control system may comprise a large number of control units and the responsibility for a specific function may be spread over more than one of them.

For sake of simplicity, FIG. 1 shows only some such control units 115, 140. However, parts of the present invention may be implemented in any suitable control unit, e.g. the control units 115, 140, or wholly or partly in one or more other control units on board the vehicle 100. Control units of the kind depicted are normally adapted to receiving sensor signals from various parts and/or control units of the vehicle. Control units are also usually adapted to delivering control signals to various parts and components of the vehicle, e.g. the control units 115, 140 may deliver signals to suitable actuators for activation of power takeoffs and/or for activation of other vehicle internal systems 120.

The control unit 115 is in FIG. 1 schematically illustrated as receiving signals and/or providing control signals from and/or to the engine 101, the clutch 106 and/or the gearbox 103. The control system 120 may, also receive and/or provide control signals to and/or from other internal systems/devices 120 in the vehicle 100.

According to some embodiments of the present invention, as described in this document, the interface control unit 148 including/implementing the add-on interface 140 may comprise configuration means 141 arranged for configuring an add-on interface, e.g. a first configuration unit 141, conversion means 142 arranged for converting between information formats, e.g. a conversion unit 142, and transfer means 143 arranged for transferring information/data, e.g. a transfer unit 143. These control means/units/devices 141, 142, 143, are described more in detail below, and may be divided physically into more entities than the herein described interface control unit 148, or may be arranged in less entities than herein described.

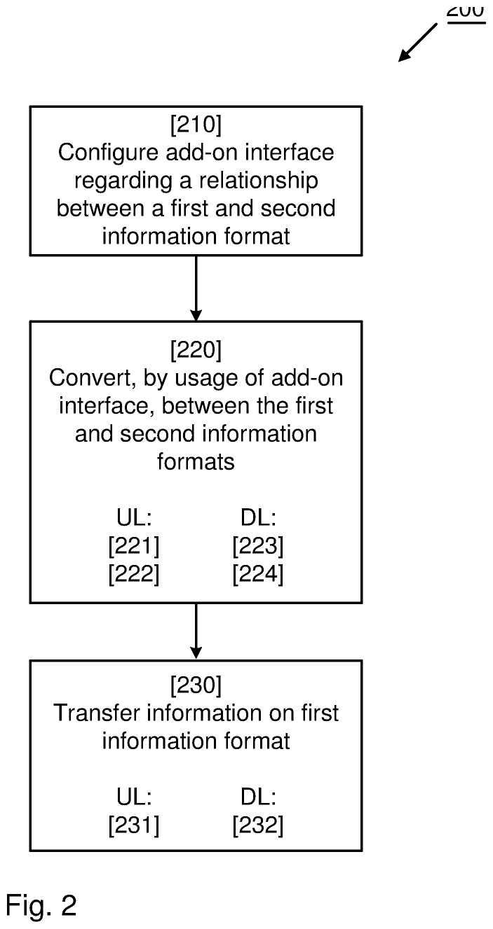

FIG. 2 shows a flow chart diagram for a method 200 according to an embodiment of the present invention, i.e. a method for transferring information to and/or from a vehicle 100. The method steps of FIG. 2 may be performed in another order than illustrated in FIG. 2, as long as the information needed for performing a method step is available when the step is to be performed.

In a first step 210 of the method according to the present invention, an add-on interface 140 of the vehicle 100 is configured by defining at least a relationship between a first information format used by the at least one internal communication unit 116, and a second information format used by one or more of the at least one vehicle internal system 120 and the at least one add-on system 130, e.g. by use of a below described configuration unit/means 141. The first information format is different from the second information format.

As mentioned above, the first information format may be used by an offboard entity, may be used for the transfer of information to and/or from the vehicle and/or may be used for onboard transfer of information between the add-on interface and the at least one internal communication unit. The second information format may be used by the onboard transfer of information between the add-on interface, and the at least one vehicle internal system and/or at least one add-on system.

In a second step 220 of the method according to the present invention, information is converted by usage of the configured add-on interface 140, between the first information format and the second information format, e.g. by use of a below described conversion unit/means 142.

In a third step 230 of the method according to the present invention, the information is transferred to and/or from the vehicle 100, by usage of the at least one internal communication unit 116, the at least one vehicle external communication unit 161, and the first information format, e.g. by use of a below described transfer unit/means 143. As is explained below in connection with some embodiments of the present invention, the information transfer in the first information format may be performed in the uplink and/or downlink direction.

By configuring the add-on interface such that it is able to convert information/data between the first information format and the second information format, a communication between essentially any offboard entity, and the at least one vehicle internal system and/or the at least one add-on system is made possible. Hereby information may reliably and securely be transferred between offboard and onboard entities/system. This configuration of the add-on interface may be achieved remotely, without having to take the vehicle into a work shop, which provides for a flexible and cost-effective handling of add-on systems.

The definition of the relationship between the first information format and the second information format may be based on input provided by essentially anyone having knowledge of the add-on systems and/or of the vehicle internal systems, e.g. a final user of the vehicle, at least one other part than the manufacturer providing and/or having knowledge of the at least one add-on system, and/or the manufacturer of the vehicle. Thus, the add-on interface may be remotely and flexibly updated/configured based on the input configuration information, wherefore the vehicle does not have to go to the workshop for the update/configuration. The vehicle off road time and the update costs are hereby greatly reduced.

According to an embodiment of the present invention, an uplink (UL) transfer of information/data is provided. Thus, information/data from one or more of the at least one vehicle internal system 120 and the at least one add-on system is transmitted/transferred offboard the vehicle to at least one offboard entity/system. The conversion 220 then includes receiving 221, to the add-on interface 140, onboard information on the second information format from the at least one vehicle internal system 120 and/or from the at least one add-on system 130. The conversion 220 further includes converting 222, by usage of the configured add-on interface 140, the information to the first information format from the second information format.

Also, for the uplink transfer of information/data, the transmission 230 includes transmitting 231 the information from the at least one internal communication unit 116 to the at least one vehicle external communication unit 161 on the first information format, i.e. transmitting 231 the information on the first information format offboard to at least one offboard entity/system.

The uplink transfer of information/data may also, according to an embodiment of the present invention, include in the configuration 210 a definition of at least one trigger condition indicating when the information should be transmitted 231 uplink offboard the vehicle 100 to at least one offboard entity/system.

The trigger condition, used for triggering the uplink transmission 231 of the information, may be related to essentially anything onboard, e.g. any action, parameter, condition, signal related to the at least one vehicle internal system 120 and/or the at least one add-on system 130 in the vehicle. The at least one trigger condition may be defined based on input provided by a final user of the vehicle 100, at least one other part than the manufacturer, the at least one other part providing the at least one add-on system 130 or having knowledge of the at least one add-on system 130, and/or the manufacturer.

By these embodiments, uplink transmission of information/data, i.e. transmission of information/data from systems onboard the vehicle to any entity offboard the vehicle, is provided. The add-on interface may execute uplink transmission of information/data when the at least one trigger condition is fulfilled, whereby a controlled uplink transmission rate/flow matching the needs and/or capabilities of the onboard systems providing the information/data and/or of the offboard entities receiving the information/data is provided.

According to an embodiment of the present invention, a downlink (DL) transfer of information/data is provided. Thus, information/data from at least one offboard entity/system is transmitted/transferred onboard to the at least one vehicle internal system 120 and/or the at least one add-on system 130. Then, the transfer 230 of information includes receiving 232 to the at least one internal communication unit 116 information on the first information format from the at least one external communication unit 161, i.e. from at least one offboard entity/system. Also, the conversion 220 of the information formats, performed by the add-on interface 140, includes converting 223 the information from the first information format to the second information format. The conversion 220 further includes providing 224 the information onboard on the second information format from the add-on interface 140 to the at least one vehicle internal system 120 and/or the at least one add-on system 130. Hereby, a downlink transmission of information/data, i.e. transmission of information/data from offboard entities/systems to systems onboard the vehicle, is provided.

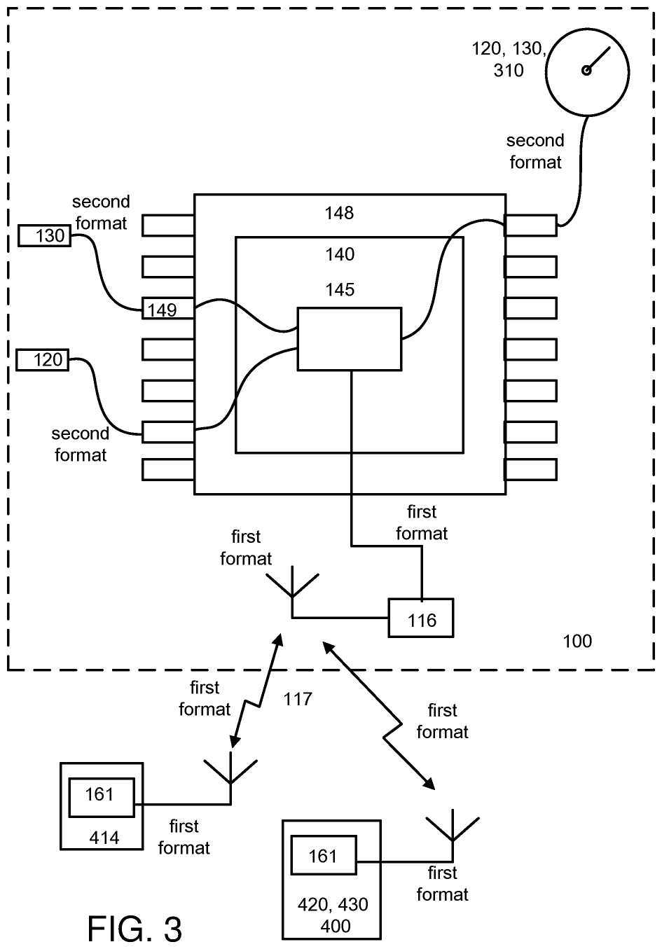

FIG. 3 schematically illustrates a non-limiting example of an embodiment of the present invention. An interface control unit 148 implementing/including the add-on interface 140 is shown. In FIG. 3, a non-limiting example of a function block 145 is illustrated. Signals carrying information on the second information format are received/provided by the add-on interface from/to a vehicle internal system 120 and/or an add-on system 130. The add-on system 130 may be connected to the add-on interface 140 by a signal connection to an input 149 of the interface control unit 148, e.g. an external CAN input pin 149. At least one of the vehicle internal 120 and/or add-on 130 system may include e.g. an instrument 310, arranged for displaying information/signals provided to it on the second information format.

The add-on interface 140, e.g. the function block 145 of the interface control unit 148, is configured such that it has knowledge of the relationship between the first information/data format and the second information/data format. Therefore, the add-on interface is able to convert information/data between the first information format and the second information format.

Since the add-on interface is able to convert information/data between the first information format and the second information format, a communication between essentially any offboard entity 414, 420, 430, 440, and the at least one vehicle internal system 120 and/or the at least one add-on system 130 is made possible.

The configuration of the add-on interface 140, may be based on configuration information provided remotely from an offboard entity 414, 420, 430,440, such as an add-on interface configuration tool 414, e.g. provided by a final user and/or a customer. As mentioned above, the configuration may be provided to the add-on interface via at least one external communication unit 161 and at least one internal communication unit 116.

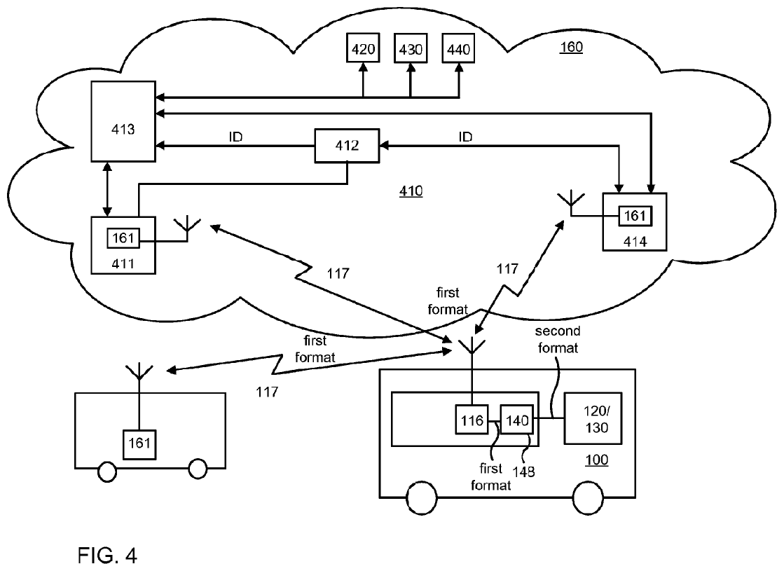

FIG. 4 schematically illustrates a system facilitating a general platform for handling vehicles including one or more add-on systems 130. As is understood by a skilled person, FIG. 4 for pedagogical reasons only shows some of the units/devices/entities/nodes in such a system. Essentially, only the units/devices/entities/nodes useful for explaining the concept are schematically illustrated in FIG. 4.

A vehicle 100, as the one described in this document, includes one or more vehicle internal systems 120, including at least one internal communication unit 116 and an interface/control unit 148 including an add-on interface 140. The vehicle 100 further includes one or more add-on systems 130, connected to the one or more vehicle internal systems 120 via the add-on interface 140, as described above. The at least one internal communication unit 116 may communicate with at least one external communication unit 161, which may be located essentially anywhere outside of the vehicle, e.g. in another vehicle and/or in one or more nodes 411, 412, 413, 414, 420, 430, 440 of an add-on/bodybuilder network 410. The one or more nodes 411, 412, 413, 414, 420, 430, 440 of the add-on/bodybuilder network 410 may be located e.g. in a web/internet/cloud related unit, in an infrastructure unit, in a server and/or in a database, as mentioned above. Generally, the add-on/bodybuilder network 410 may be implemented as an internet cloud 160 related solution. Generally, the one or more nodes 411, 412, 413, 414, 420, 430, 440 of an add-on/bodybuilder network 410 are in FIG. 4 for pedagogic reasons illustrated as separate nodes. However, these nodes may be implemented less nodes than illustrated in FIG. 4.

The add-on interface 140 utilized for the embodiments of the present invention may be an advanced and flexible interface provided with advanced logical functionality and possibilities for flexible definition of interface inputs and/or outputs. According to an embodiment, the logical functionality providable by the add-on interface 140 includes essentially any useful logical, numerical and/or mathematical operations, that may be operated on one or more signals input to the add-on interface 140. The input signals may here, according to various embodiments, include essentially any kind of signal, such as digital and/or analog signals, comprising well defined signal value levels and/or numerical signal values. Thus, the add-on interface 140 used by the embodiments of the present invention may be considerably more advanced than conventional add-on interfaces are, including e.g. processing of numerical signals, representation of physical values as numerical values, and/or performing numerical operations on the numerical values/signals.

The add-on interface 140 may also easily be configured such that it is able to interpret the signals/information being input to it from the one or more add-on systems 130, e.g. via an external control system network input, such as an external controller area network (CAN) input, of the interface/control unit 148 including the add-on interface 140. The add-on interface 140 may also easily be configured to output signals/information to the one or more add-on systems 130, via the external controller area network (CAN), such that the signals/information may be interpreted/used by the add-on systems 130. The add-on interface 140 may be arranged for converting signaling/information formats being used by the one or more add-on systems 130 to signaling/information formats being used by the one or more vehicle internal systems 120, and vice versa. Hereby, the one or more add-on systems 130 may communicate with the one or more vehicle internal systems 120, and possibly also with other systems, such as systems related to, or being included in the add-on/bodybuilder network 410.

Further, the add-on interface 140 may also be easily configured for interpreting sensor signals being provided by the one or more add-on systems 130, such that a flexibility regarding addition of sensors is achieved for the vehicle. Essentially, any type of sensor, providing any type of sensor signal having essentially any features, e.g. indicating any type of physical quantity unit may be implemented in the one or more add-on systems 130, whereby the add-on interface 140 is configured to process the provided sensor signal accordingly. The add-on interface 140 may also be easily configured to output a processed sensor signal having suitable features to the one or more vehicle internal systems 120, such as e.g. to the instrument cluster of the driving compartment, and possibly also to other systems, such as systems/nodes related to, or being included in the add-on/bodybuilder network 410. The add-on interface 140 may for example be configured for outputting sensor signals adapted for being displayed in any suitable vehicle instrument.

The add-on network 410 may further include an add-on interface configuration tool 414, which may include an external communication unit 161 arranged for communicating with the at least one internal communication unit 116 included in the vehicle. By use of the add-on interface configuration tool 414, the add-on interface 140 may easily be configured and/or defined, as is described in this document. Information related to how the add-on interface 140 is to be configured/defined may be provided based on input to a manufacturer interface entity 420 and/or a client/user interface entity 430 by a manufacturer and/or a client/user. One or more of the manufacturer interface entity 420 and the client/user interface entity 430 may be implemented as an application (APP) program, as an interface portal, as an interface program, or as any suitable equipment arranged for presenting information and/or for receiving input of information.

An add-on/bodybuilder network 410 may be arranged, e.g. in an internet cloud 160 configuration, for communication and/or configuration of the one or more add-on systems 130, and/or for communication with the manufacturer interface entity 420 and/or the client/user interface entity 430. The add-on network 410 may include a communication node 411, which may include an external communication unit 161 arranged for communicating with the at least one internal communication unit 116 included in the vehicle.

Information transmitted to and/or from the vehicle 100 may have one or more features related to one or more configured functions of the add-on interface 140 and/or related to a configured signaling format used for the connection between the at least one internal communication unit 116 and the at least one external communication unit 161. According to some embodiments, an immutable and unique identifier ID may be created based on, and assigned to, the specific configuration of the add-on interface functions and/or of the used signaling.

Generally, the add-on interface configuration tool 414, the manufacturer interface entity 420 and/or the client/user interface entity 430 is normally unaware of the features of the one or more add-on systems 130 and/or of the configuration of the add-on interface 140. Therefore, the add-on interface configuration tool 414, the manufacturer interface entity 420 and/or the client/user interface entity 430 are often also unaware of how to interpret information provided by the one or more add-on systems 130 to them. The immutable and unique identifier ID may therefore be added, e.g. as included in a packet header, to information sent from the one or more add-on systems 130. The information may then be decoded, in a codec 413 connected to the communication node 411, by usage of this immutable and unique identifier ID. The immutable and unique identifier ID may, after having been previously provided by the add-on interface 140 and/or by the add-on interface configuration tool 414, be stored in a register 412 of the add-on network 410. The codec 413 is arranged for encoding and/or decoding information transmitted from and/or to the vehicle 100, e.g. by usage of the immutable and unique identifier ID, which is then provided to the codec 413 by the register 412.

Thus, the codec 413 may detect the immutable and unique identifier ID in a packet header of information transmitted from the vehicle 100, and may therefore be able to determine the specific configuration of the add-on interface 140 and how to detect the information in the packets. Correspondingly, the immutable and unique identifier ID may also be added, e.g. in a packet header, to information transmitted to the vehicle 100. The add-on interface 140 may then, based on the immutable and unique identifier ID, easily identify to which one or more add-on systems 130 and/or one or more vehicle internal systems 120 the information is intended to be transferred.

One or more diagnosis equipment 440 may be arranged in the add-on network 410 to process diagnosis related information. Such one or more diagnosis equipment may for example be included in the manufacturer interface entity 420 and/or in the client/user interface entity 430, or may be implemented in a separate diagnosis equipment 440. The one or more diagnosis equipment 440 is normally unaware of the features of the possibly unknown one or more add-on systems 130 and/or of the configuration of the add-on interface 140. Therefore, in order to provide a generic diagnosis system, diagnostic identifiers are created based on, and assigned to, the specific configuration of the add-on interface 140 and/or the one or more add-on systems 130. Hereby, the diagnosis equipment 440 may be able to provide a reliable diagnosis also for all add-on systems 130, also for the ones being unknown for the diagnosis equipment.

The person skilled in the art will appreciate that a method for transferring information to and/or from a vehicle according to the present invention may also be implemented in a computer program, which, when it is executed in a computer, instructs the computer to execute the method. The computer may be included in the herein described system and/or may be coupled/connected to the herein described system. The computer program is usually constituted by a computer program product 503 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

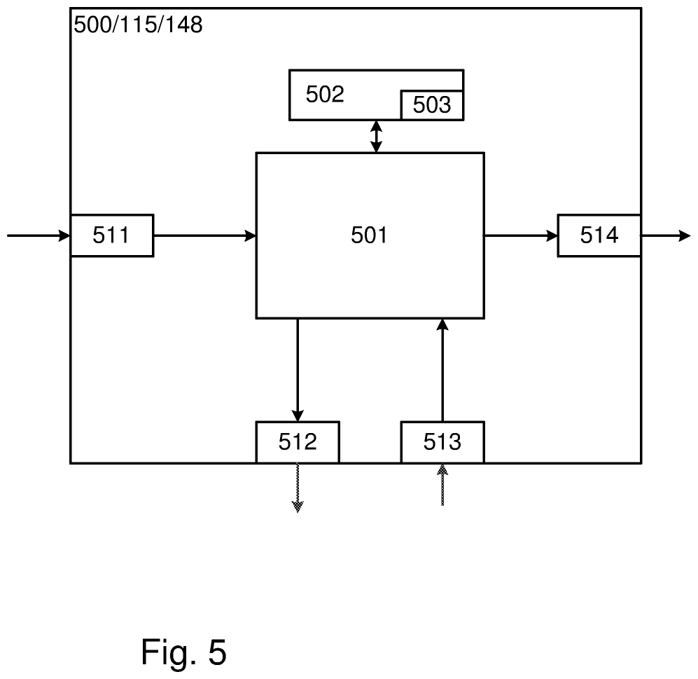

FIG. 5 shows in schematic representation a control unit/system/means 500/115/148. As mentioned above, the vehicle 100 may include one or more control units 115. Also, the add-on interface 140 may be implemented as a control unit. The control unit/system/means 500/115/148 comprises a computing unit 501, which may be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 501 is connected to a memory unit 502 arranged in the control unit/system/means 500/115/148, which memory unit provides the computing unit 501 with, for example, the stored program code and/or the stored data which the computing unit 501 requires to be able to perform computations. The computing unit 501 is also arranged to store partial or final results of computations in the memory unit 502.

In addition, the control unit/system/means 500/115/148 is provided with devices 511, 512, 513, 514 for receiving and transmitting input and output signals. These input and output signals may comprise waveforms, impulses, or other attributes which, by the devices 511, 513 for the reception of input signals, can be detected as information and can be converted into signals which can be processed by the computing unit 501. These signals are then made available to the computing unit 501. The devices 512, 514 for the transmission of output signals are arranged to convert signals received from the computing unit 501 in order to create output signals by, for example, modulating the signals, which can be transmitted to other parts of and/or systems within or outside the vehicle 100.

Each of the connections to the devices for receiving and transmitting input and output signals can be comprise one or more of a cable; a data bus, such as a CAN bus (Controller Area Network bus), a MOST bus (Media Orientated Systems Transport bus), or some other bus configuration; or by a wireless connection. A person skilled in the art will appreciate that the above-stated computer can be constituted by the computing unit 501 and that the above-stated memory may be constituted by the memory unit 502.

Control systems in modern vehicles commonly comprise communication bus systems including one or more communication buses for linking a number of electronic control units (ECU's), or controllers, and various components located on the vehicle. Such a control system may comprise a large number of control units/means and the responsibility for a specific function can be divided amongst more than one control unit/means. Vehicles of the shown type thus often comprise significantly more control units/means than are shown in FIGS. 1 and 5, which is well known to the person skilled in the art within this technical field.

In the shown embodiment, the present invention is implemented in the control unit/system/means 500/115/148. The invention can also, however, be implemented wholly or partially in one or more other control units/systems/means already present in the vehicle, or in some control unit/system/means dedicated to the present invention.

According to an aspect of the invention, a control unit 140 arranged for transferring information to and/or from a vehicle.

The control unit 140 includes a configuration unit/means 141, arranged for configuring 210 an add-on interface 140 of the vehicle 100 by defining at least a relationship between a first information format used by the at least one internal communication unit 116 and a second information format used by one or more of the at least one vehicle internal system 120 and the at least one add-on system 130, as described above.

The control system further includes a conversion unit/means 142, arranged for converting 220, by usage of the configured add-on interface 140, information between the first information format and the second information format, as described above.

The control system 120 also includes a transfer unit/means 143, arranged for transferring 230 the information to and/or from the vehicle 100, by usage of the at least one internal communication unit 116, the at least one vehicle external communication unit 161, and the first information format, as described above.

By activation of the above described configuration unit/means 141, conversion unit/means 142, and transfer unit/means 143, the information transfer to and/or from the vehicle is provided, which has the above-mentioned advantages.

Here and in this document, units/means are often described as being arranged for performing steps of the method according to the invention. This also includes that the units/means are designed to and/or configured to perform these method steps.

The at least one interface control unit/system/means 148 is in FIG. 1 illustrated as including separately illustrated units/means 141, 142, 143. Also, the control system/means 140 may include or be coupled to e.g. other device/means 115. These means/units/devices 141, 142, 143, 148, 115 may, however, be at least to some extent logically separated but implemented in the same physical unit/device. These means/units/devices 141, 142, 143, 148, 115 may also be part of a single logic unit which is implemented in at least two different physical units/devices. These means/units/devices 141, 142, 143, 148, 115 may also be at least to some extent logically separated and implemented in at least two different physical means/units/devices. Further, these means/units/devices 141, 142, 143, 148, 115 may be both logically and physically arranged together, i.e. be part of a single logic unit which is implemented in a single physical means/unit/device. These means/units/devices 141, 142, 143, 148, 115 may for example correspond to groups of instructions, which can be in the form of programming code, that are input into, and are utilized by at least one processor when the units/means are active and/or are utilized for performing its method step, respectively. It should be noted that the interface control system/means 148 may be implemented at least partly within the vehicle 100 and/or at least partly outside of the vehicle 100, e.g. in a server, computer, processor or the like located separately from the vehicle 100.

As mentioned above, the units 141, 142, 143 described above correspond to the claimed means 141, 142, 143 arranged for performing the embodiments of the present invention, and the present invention as such.

The control system according to the present invention can be arranged for performing all of the above, in the claims, and in the herein described embodiments method steps. The system is hereby provided with the above described advantages for each respective embodiment.

A skilled person also realizes that the above described system may be modified according to the different embodiments of the method of the present invention. The present invention is also related to a vehicle 100, such as a truck, a bus or a car, including the herein described interface control unit 148 arranged for transferring information to and/or from a vehicle.

The inventive method, and embodiments thereof, as described above, may at least in part be performed with/using/by at least one device. The inventive method, and embodiments thereof, as described above, may be performed at least in part with/using/by at least one device that is suitable and/or adapted for performing at least parts of the inventive method and/or embodiments thereof. A device that is suitable and/or adapted for performing at least parts of the inventive method and/or embodiments thereof may be one, or several, of a control unit, an electronic control unit (ECU), an electronic circuit, a computer, a computing unit and/or a processing unit.

With reference to the above, the inventive method, and embodiments thereof, as described above, may be referred to as an, at least in part, computerized method. The method being, at least in part, computerized meaning that it is performed at least in part with/using/by the at least one device that is suitable and/or adapted for performing at least parts of the inventive method and/or embodiments thereof.

With reference to the above, the inventive method, and embodiments thereof, as described above, may be referred to as an, at least in part, automated method. The method being, at least in part, automated meaning that it is performed with/using/by the at least one device that is suitable and/or adapted for performing at least parts of the inventive method and/or embodiments thereof.

The present invention is not limited to the above described embodiments. Instead, the present invention relates to, and encompasses all different embodiments being included within the scope of the independent claims.

1. A method for transferring information to and/or from a vehicle, said vehicle comprising: at least one vehicle internal system; at least one add-on system, said add-on system being arranged in said vehicle after said vehicle is produced by a manufacturer; and at least one internal communication unit configured to communicate with at least one vehicle external communication unit,
wherein the method comprises:
configuring an add-on interface of said vehicle by defining at least a relationship between a first information format used by said at least one internal communication unit and a second information format used by one or more of said at least one vehicle internal system and said at least one add-on system;
converting, using the configured add-on interface, information between said first information format and said second information format; and
transferring said information to and/or from said vehicle, using said at least one internal communication unit, said at least one vehicle external communication unit, and said first information format.

2. The method as claimed in claim 1, wherein
said converting comprises:
receiving information on said second information format from one or more of said at least one vehicle internal systems and at least one add-on system; and
converting, using the configured add-on interface, said information to said first information format; and
said transferring comprises:
transmitting said information from said at least one internal communication unit to said at least one vehicle external communication unit on said first information format.

3. The method as claimed in claim 2, wherein said configuring further at least comprises defining at least one trigger condition, said trigger condition indicating when said transmitting of said information should be performed.

4. The method as claimed in claim 3, wherein said defining of said trigger condition is related to one or more of:
said at least one vehicle internal system; and/or
said at least one add-on system.

5. The method as claimed in claim 2, wherein said at least one trigger condition is defined based on input provided by one or more of:
a final user of said vehicle;
at least one other part than said manufacturer, said at least one other part providing said at least one add-on system; and/or
said manufacturer.

6. The method as claimed in claim 1, wherein
said transferring comprises:
receiving information on said first information format from said at least one external communication unit; and
said converting comprises:
converting, using the configured add-on interface, said information to said second information format; and
providing said information on said second information format to one or more of said at least one vehicle internal system and said at least one add-on system.

7. The method as claimed in claim 1, wherein said at least one vehicle external communication unit is included in and/or is associated with one or more of:
at least one web and/or internet related unit;
at least one internet cloud related unit;
at least one infrastructure unit;
at least one external communication unit included in at least one other vehicle;
at least one server;
at least one database;
at least one processor; and/or
at least one computer.

8. The method as claimed in claim 1, wherein:
said at least one internal communication unit is included in a control system network of said vehicle; and
said first information format is a format used by said control system network.

9. The method as claimed in claim 8, wherein said at least one add-on system is connected to an external control system network input of an interface control unit including said add-on interface.

10. The method as claimed in claim 1, wherein said at least one internal communication unit is configured to communicate with said at least one vehicle external communication unit using one or more of:
a wireless communication standard connection; and/or
a wired connection.

11. The method as claimed in claim 1, wherein said at least one add-on system is a system provided by at least one other part than said manufacturer of said vehicle.

12. The method as claimed in claim 1, wherein defining said relationship between said first information format and said second information format is based on input provided by one or more of:
a final user of said vehicle;
at least one other part than said manufacturer, said at least one other part providing said at least one add-on system;
at least one other part than said manufacturer, said at least one other part having knowledge of said at least one add-on system; and/or
said manufacturer.

13. A computer program product comprising computer program code stored on a non-transitory computer-readable medium, said computer program product used for transferring information to and/or from a vehicle, said vehicle comprising: at least one vehicle internal system; at least one add-on system, said add-on system being arranged in said vehicle after said vehicle is produced by a manufacturer; and at least one internal communication unit configured to communicate with at least one vehicle external communication unit, said computer program code comprising computer instructions to cause one or more control units to perform the following operations:
configuring an add-on interface of said vehicle by defining at least a relationship between a first information format used by said at least one internal communication unit and a second information format used by one or more of said at least one vehicle internal system and said at least one add-on system;
converting, using the configured add-on interface, information between said first information format and said second information format; and
transferring said information to and/or from said vehicle, using said at least one internal communication unit, said at least one vehicle external communication unit, and said first information format.

14. (canceled)

15. A control unit configured to transfer information to and/or from a vehicle, said vehicle comprising: at least one vehicle internal system; at least one add-on system, said add-on system being arranged in said vehicle after said vehicle is produced by a manufacturer; and at least one internal communication unit configured to communicate with at least one vehicle external communication unit,
said control unit configured to:
configure an add-on interface of said vehicle by defining at least a relationship between a first information format used by said at least one internal communication unit and a second information format used by one or more of said at least one vehicle internal system and said at least one add-on system;
convert, using the configured add-on interface, information between said first information format and said second information format; and
transfer said information to and/or from said vehicle, using said at least one internal communication unit, said at least one vehicle external communication unit, and said first information format.
